(19) United States
(12) Patent Application Publication
(10) Pub. No.: US 2007/0030711 A1
(43) Pub. Date: Feb. 8, 2007

(54) Power supply adapter for connecting multiple loads

(76) Inventor: Su-Miao Liu, Jiji Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/364,639

(22) Filed: Feb. 27, 2006

(30) Foreign Application Priority Data
Aug. 2, 2005 (TW) 94126216

(51) Int. Cl. H02H 7/122

(52) U.S. Cl. 363/55

(57) ABSTRACT

A power supply adapter includes an input terminal to input an alternating current power supply, a converter circuit electrically connected to the input terminal to convert the alternating current power supply into multiple direct current voltage signals and multiple alternating current voltage signals, a plurality of direct current voltage output terminals electrically connected to the converter circuit, and a plurality of alternating current voltage output terminals electrically connected to the converter circuit. Thus, the power supply adapter converts the single alternating current power supply into multiple direct current voltage signals and multiple alternating current voltage signals for use with multiple loads, so that the power supply adapter is available for multiple direct current loads and multiple alternating current loads.

### BACKGROUND OF THE INVENTION

1. Field of the Invention

The present invention relates to a power supply adapter and, more particularly, to a power supply adapter for connecting multiple loads.

2. Description of the Related Art

A conventional power supply adapter 1 in accordance with the prior art shown in FIG. 4 has a first end provided with an output plug 11 connected to an electric appliance, such as a cell phone and a second end provided with an input plug 10 connected to a wall type socket (not shown) to input an alternating current power supply into the power supply adapter 1. A converter circuit (not shown) is mounted in the power supply adapter 1 to convert the alternating current power supply into a direct current voltage for use with the cell phone. However, the power supply adapter 1 is only available for a single electric appliance, thereby limiting the versatility of the power supply adapter.

Another conventional power supply adapter in accordance with the prior art shown in FIG. 5 comprises an adapter body 3 having a first side provided with a connector 35 connected to an electric appliance, such as a liquid crystal display 36 and a second side provided with a socket 31, and an alternating current cable 32 having a first end provided with an output plug 33 connected to the socket 31 and a second end provided with an input plug 34 connected to a wall type socket (not shown) to input an alternating current power supply into the adapter body 3. A converter circuit (not shown) is mounted in the adapter body 3 to convert the alternating current power supply into a direct current voltage for use with the liquid crystal display 36. However, the power supply adapter is only available for a single electric appliance, thereby limiting the versatility of the power supply adapter.

### SUMMARY OF THE INVENTION

In accordance with the present invention, there is provided a power supply adapter, comprising an input terminal to input an alternating current power supply, a converter circuit electrically connected to the input terminal to convert the alternating current power supply of the input terminal into multiple direct current voltage signals and multiple alternating current voltage signals, a plurality of direct current voltage output terminals electrically connected to the converter circuit, and a plurality of alternating current voltage output terminals electrically connected to the converter circuit.

The primary objective of the present invention is to provide a power supply adapter for connecting multiple loads.

Another objective of the present invention is to provide a power supply adapter, wherein the power supply adapter converts the single alternating current power supply into multiple direct current voltage signals and multiple alternating current voltage signals for use with multiple loads, so that the power supply adapter is available for multiple direct current loads and multiple alternating current loads, thereby enhancing the versatility of the power supply adapter.

A further objective of the present invention is to provide a power supply adapter, wherein the power supply adapter provides multiple direct current sockets and plugs and multiple alternating current sockets and plugs for use with multiple loads without having to provide multiple electric cords, thereby facilitating a user operating the power supply adapter.

A further objective of the present invention is to provide a power supply adapter, wherein the power supply adapter adopts a parallel connected manner to convert a single input signal into multiple output signals so as to reduce the voltage and the current.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a power supply adapter in accordance with the preferred embodiment of the present invention.

FIG. 2 is an exploded perspective view of the power supply adapter as shown in FIG. 1.

FIG. 3 is a perspective view of the power supply adapter for use with multiple loads as shown in FIG. 1.

FIG. 4 is a perspective view of a conventional power supply adapter in accordance with the prior art.

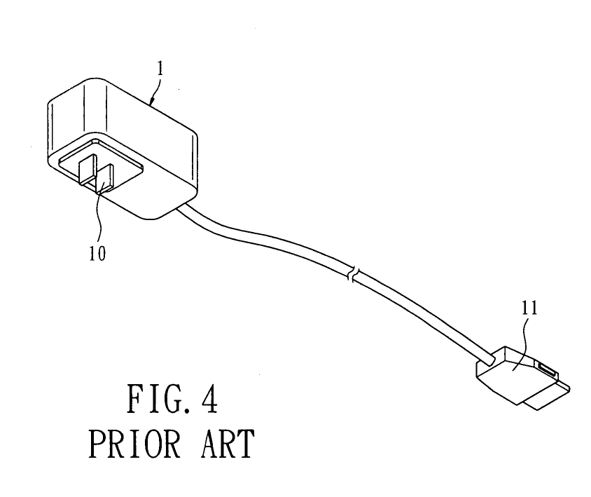

FIG. 5 is a perspective view of another conventional power supply adapter in accordance with the prior art.

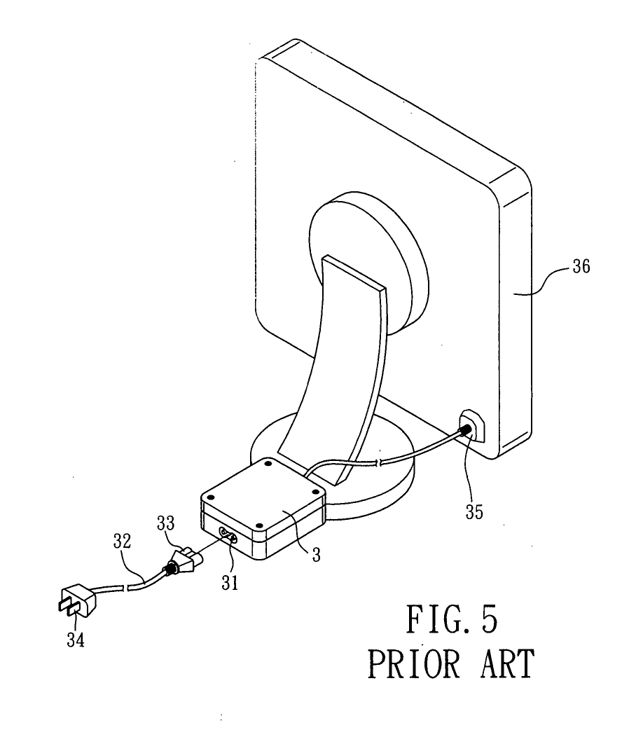

### DETAILED DESCRIPTION OF THE INVENTION

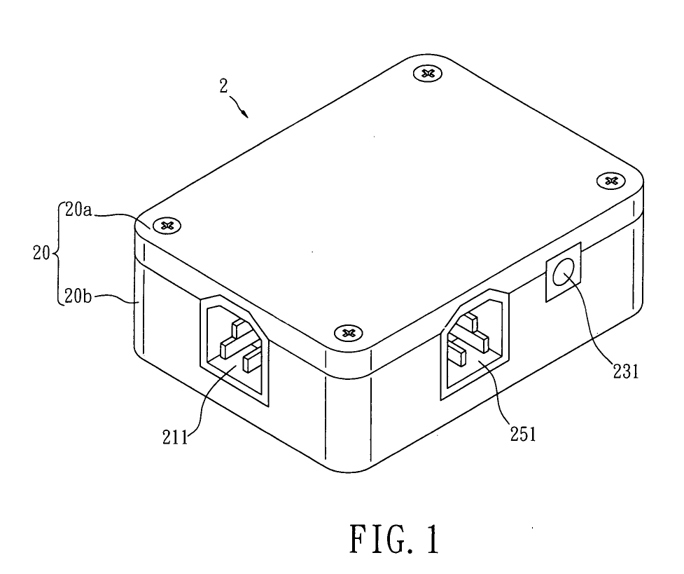

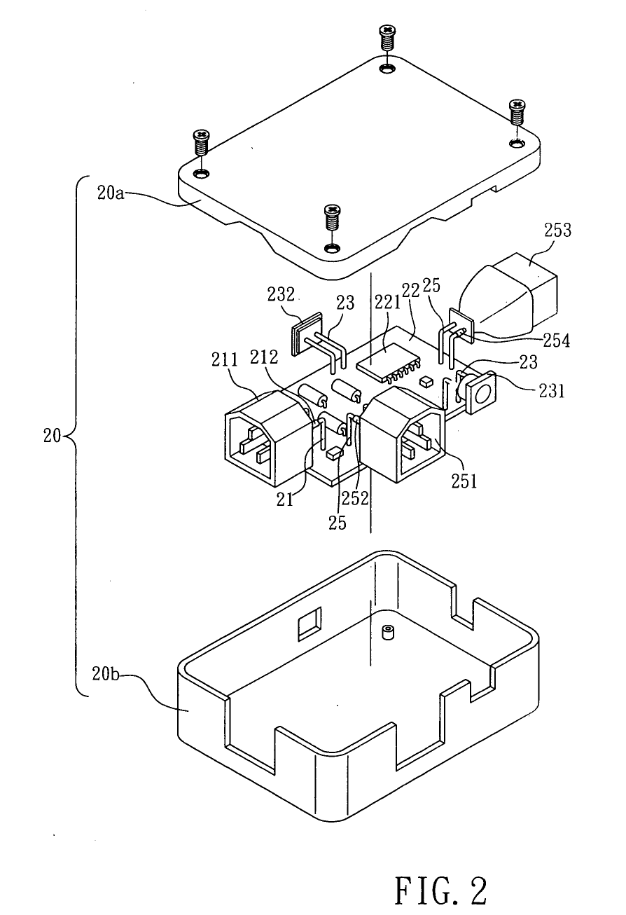

Referring to the drawings and initially to FIGS. 1 and 2, a power supply adapter 2 in accordance with the preferred embodiment of the present invention comprises an input terminal 21 to input an alternating current power supply, a converter circuit 22 electrically connected to the input terminal 21 to convert the alternating current power supply of the input terminal 21 into multiple direct current voltage signals and multiple alternating current voltage signals, a plurality of direct current voltage output terminals 23 electrically connected to the converter circuit 22 to output the direct current voltage signals of the converter circuit 22, a plurality of alternating current voltage output terminals 25 electrically connected to the converter circuit 22 to output the alternating current voltage signals of the converter circuit 22, and a housing 20 to support the input terminal 21, the converter circuit 22, the direct current voltage output terminals 23, and the alternating current voltage output terminals 25.

The housing 20 has a rectangular shape and includes a first casing 20a and a second casing 20b combined with each other.

The input terminal 21 is connected to an alternating current socket 211 or an alternating current plug (not shown). The alternating current socket 211 is mounted on a side of the housing 20 to input the alternating current power supply into the input terminal 21. The alternating current power supply of the input terminal 21 contains a first voltage of 110 volts and a second voltage of 220 volts.

The converter circuit 22 is mounted in the housing 20. The converter circuit 22 includes a transformer, a rectifier, a filter and a voltage regulator which are integrated into an integrated circuit (I.C.) 221. Thus, the converter circuit 22 converts the alternating current power supply of the input terminal 21 into multiple direct current voltage signals stably which are connected to the direct current voltage output terminals 23 which are connected to a plurality of direct current loads, and into multiple alternating current voltage signals stably which are connected to the alternating current voltage output terminals 25 which are connected to a plurality of alternating current loads.

In the preferred embodiment of the present invention, the power supply adapter 2 adopts a parallel connected manner to convert a single input signal into multiple output signals so as to reduce the voltage and the current.

The direct current voltage output terminals 23 are connected to a direct current socket 231 and a direct current plug 232 respectively. For example, the direct current socket 231 is a socket (having a single slot) used by a liquid crystal display. The alternating current voltage output terminals 25 are connected to an alternating current socket 251 and an alternating current plug 253 respectively. For example, the alternating current socket 251 is a socket having two or three legs. Similarly, the alternating current plug 253 is a plug having two or three legs.

In the preferred embodiment of the present invention, a fuse 212 is mounted between the input terminal 21 and the alternating current socket 211 to prevent an overload of the electric current from the alternating current socket 211 into the input terminal 21, thereby preventing the converter circuit 22 from being worn out. In addition, a fuse 252 is mounted between the alternating current socket 251 and the respective alternating current voltage output terminal 25 to prevent an overload of the electric current from the respective alternating current voltage output terminal 25 into the alternating current socket 251 to stabilize the electric current into the load. In addition, a fuse 254 is mounted between the alternating current plug 253 and the respective alternating current voltage output terminal 25 to prevent an overload of the electric current from the respective alternating current voltage output terminal 25 into the alternating current plug 253 to stabilize the electric current into the load.

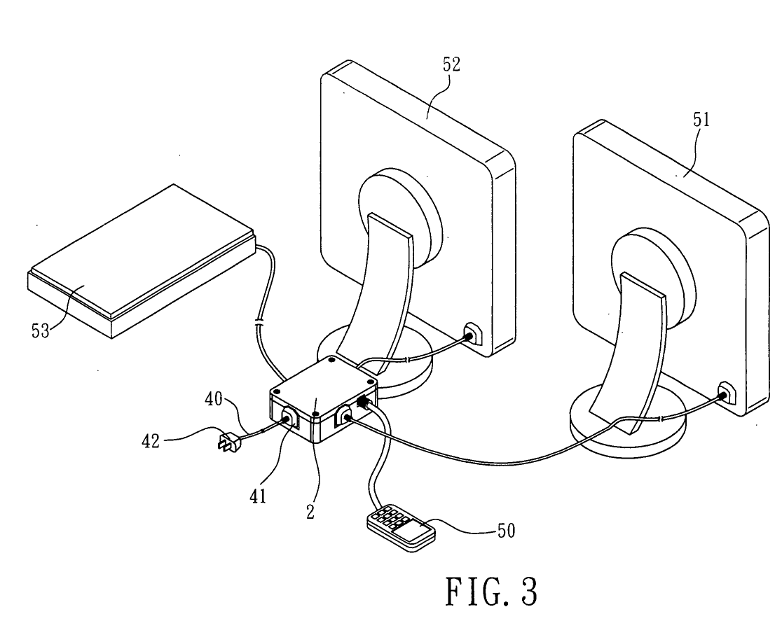

As shown in FIGS. 1-3, an alternating current cable 40 has a first end provided with an output plug 41 connected to the alternating current socket 211 of the power supply adapter 2 and a second end provided with an input plug 42 connected to a wall type socket (not shown) to input the alternating current power supply into the alternating current socket 211 and the input terminal 21 of the power supply adapter 2. The alternating current cable 40 is usually attached to an electric appliance so that the consumer needs not to buy the alternating current cable 40 additionally. Thus, after the converter circuit 22 obtains the alternating current power supply from the input terminal 21, the converter circuit 22 converts the alternating current power supply of the input terminal 21 into multiple direct current voltage signals and multiple alternating current voltage signals for use with multiple loads 50, 51, 52 and 53.

Accordingly, the power supply adapter 2 converts the single alternating current power supply into multiple direct current voltage signals and multiple alternating current voltage signals for use with multiple loads, so that the power supply adapter 2 is available for multiple direct current loads and multiple alternating current loads, thereby enhancing the versatility of the power supply adapter 2. In addition, the power supply adapter 2 provides multiple direct current sockets and plugs and multiple alternating current sockets and plugs for use with multiple loads without having to provide multiple electric cords, thereby facilitating a user operating the power supply adapter 2. Further, the power supply adapter 2 adopts a parallel connected manner to convert a single input signal into multiple output signals so as to reduce the voltage and the current.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A power supply adapter, comprising:
an input terminal to input an alternating current power supply;
a converter circuit electrically connected to the input terminal to convert the alternating current power supply of the input terminal into multiple direct current voltage signals and multiple alternating current voltage signals;
a plurality of direct current voltage output terminals electrically connected to the converter circuit;
a plurality of alternating current voltage output terminals electrically connected to the converter circuit.

2. The power supply adapter in accordance with claim 1, wherein the direct current voltage output terminals output the direct current voltage signals of the converter circuit.

3. The power supply adapter in accordance with claim 1, wherein the alternating current voltage output terminals output the alternating current voltage signals of the converter circuit.

4. The power supply adapter in accordance with claim 1, wherein the input terminal is connected to an alternating current socket.

5. The power supply adapter in accordance with claim 1, wherein the input terminal is connected to an alternating current plug.

6. The power supply adapter in accordance with claim 1, wherein the alternating current power supply of the input terminal contains a first voltage of 110 volts and a second voltage of 220 volts.

7. The power supply adapter in accordance with claim 1, wherein the power supply adapter adopts a parallel connected manner to convert a single input signal into multiple output signals.

8. The power supply adapter in accordance with claim 1, wherein one of the direct current voltage output terminals is connected to a direct current socket.

9. The power supply adapter in accordance with claim 1, wherein one of the direct current voltage output terminals is connected to a direct current plug.

10. The power supply adapter in accordance with claim 1, wherein one of the alternating current voltage output terminals is connected to an alternating current socket.

11. The power supply adapter in accordance with claim 1, wherein one of the alternating current voltage output terminals is connected to an alternating current plug.

12. The power supply adapter in accordance with claim 4, further comprising a fuse mounted between the input terminal and the alternating current socket.

13. The power supply adapter in accordance with claim 10, further comprising a fuse mounted between the alternating current socket and the respective alternating current voltage output terminal.

14. The power supply adapter in accordance with claim 11, further comprising a fuse mounted between the alternating current plug and the respective alternating current voltage output terminal.

15. The power supply adapter in accordance with claim 1, further comprising a housing to support the input terminal, the converter circuit, the direct current voltage output terminals, and the alternating current voltage output terminals.

16. The power supply adapter in accordance with claim 15, wherein the input terminal is connected to an alternating current socket which is mounted on a side of the housing to input the alternating current power supply into the input terminal.

17. The power supply adapter in accordance with claim 15, wherein the converter circuit is mounted in the housing.
